(19) United States
(12) Patent Application Publication
(10) Pub. No.: US 2002/0086205 A1
(43) Pub. Date: Jul. 4, 2002

(54) Electrical connection system for electrochemical cells

(75) Inventors: Stephane Payen, Hiersac (FR); Laurent Souliac, Le Bouscat (FR)

Correspondence Address: SUGHRUE, MION, ZINN,, MACPEAK & SEAS, PLLC, Suite 800, 2100 Pennsylvania Avenue, N.W., Washington, DC, 20037-3213, US

(73) Assignee: ALCATEL

(21) Appl. No.: 10/026,440

(22) Filed: Dec. 27, 2001

(30) Foreign Application Priority Data
Jan. 4, 2001 (FR) 01 00 076

(51) Int. Cl. H01M 2/24; H01M 2/30

(52) U.S. Cl. 429/158; 429/178; 29/623.4

(57) ABSTRACT

An electrochemical cell presents two poles disposed on opposite faces. Each pole has an endpiece with at least one projecting substantially plane portion. Each of these portions is shaped so as to be capable of being placed against a projecting plane portion of the other pole of another electrochemical cell by means of a movement in translation. The invention enables electrochemical cells to be assembled together simply and quickly. The position and shape of the endpieces is suitable for allowing welding tools to pass. Assembly impedance is low because of the large current-passing section and because of the way assembly is performed.

The invention relates to high-power electrochemical cells (high discharge current: I>50 amps (A)), and it relates more particularly to mechanical and electrical connections between such cells.

### BACKGROUND OF THE INVENTION

It is common practice to place a plurality of electrochemical cells in series so as to sum the voltages of the cells. It is also known that high-power cells can be assembled to make up a stick or a battery by means of screw threads. Such cells have a conductive male threaded terminal on their positive poles and a female threaded terminal on their negative poles, or vice versa. The male terminal of one cell is screwed into the female terminal of another cell so as to assemble them together. That type of assembly serves simultaneously to provide mechanical and electrical connection between the two cells by means of a screw thread. Nickel-plating treatment makes it possible to reduce contact impedance. Such assemblies nevertheless present drawbacks. They require screw-machined pieces to be produced that are difficult to machine and that need to be nickel-plated. Nickel plating is also an impediment to welding the terminals to the poles of the cells. Furthermore, screw assemblies are not reliable: they are sensitive to vibration both during assembly and when in use. Furthermore, contact impedances are high and vary depending on the quality of assembly. Finally, that type of assembly operation is difficult to automate and puts a limit on battery manufacturing rates.

It is also known from document FR-A-2 335 962 to provide a battery comprising at least two electrochemical cells each having a metal case forming a terminal of a first polarity, and a terminal of opposite polarity that projects from the opening in the case, wherein two cells are interconnected electrically and mechanically by a connection cup which is engaged on the case of one of the cells and is welded thereto via its edge, and which is also welded to the opposite-polarity terminal of the other cell via its disk.

Document EP-A-0 717 453 also discloses a method of assembling a battery made up of a plurality of cells connected in series for the purpose of improving charging/discharging performance and also improving productivity. A convex end pole formed on top of one cell is initially welded to one end of a conductive terminal, and the other cell is placed above the cell connected to the conductive terminal in such a manner that the axes of these two cells extend in the same direction, and while in this configuration, the flat end pole formed on the bottom portion of the other cell and the other end of the conductive terminal are welded together indirectly.

Document EP-0 235 976 shows cylindrical cells interconnected by means of flexible conductors which are firstly placed side by side so as to be welded or soldered, and are then folded so as to occupy the space between two cells. Those conductors are of small thickness so as to be sufficiently flexible to enable them to be folded. They are not of sufficient section to enable them to pass high currents. That connection method is therefore not suitable for use with high-power electrochemical cells.

### OBJECTS AND SUMMARY OF THE INVENTION

The invention proposes a solution to those problems. In particular it proposes an electrochemical cell suitable for being electrically connected to another cell to pass high currents in a manner that is quick and reliable, with low connection impedance and with improved access for welding tools. It also enables a battery of such cells to be cooled more effectively.

More precisely, the invention provides an electrochemical cell presenting two poles disposed on opposite faces, at least one of the poles having a conductive endpiece presenting at least one substantially plane portion projecting from said pole axially relative to the cell, said endpiece being shaped so as to be suitable for assembling with an endpiece of another electrochemical cell by a movement in translation in such a manner that said projecting plane portions of each of said endpieces placed against each other, plane-on-plane.

In a variant, said endpiece presents at least two substantially plane perpendicular portions.

In an embodiment, the endpieces are made of angle sections.

In a variant, an angle section has a U-shaped section.

In another variant, an angle section has an L-shaped section.

In a particular embodiment of the invention, a projecting plane portion has an opening shaped to receive a portion, in particular a plane portion, of an endpiece of another electrochemical cell passing therethrough.

In a variant, the two endpieces present coplanar faces for placing against faces of endpieces of other cells.

The invention also provides an assembly comprising a first electrochemical cell and a second electrochemical cell, each of said cells having at least one endpiece as defined above. Preferably, the second cell has an endpiece identical to one of the endpieces of the first cell.

Advantageously, a space giving access to the projecting plane portions is provided between the electrochemical cells when the endpieces are placed one against the other. Preferably, the length of the projecting plane portion is sufficient to enable a fixing tool to pass, for welding or soldering.

The invention also provides a method of assembling two electrochemical cells of the invention, the method comprising the steps consisting in: placing projecting plane portions of two endpieces of the two cells in plane-on-plane contact by a movement in translation; and fixing the two endpieces to each other.

In an implementation, the step of interconnecting the two endpieces includes a stage of welding them together via their flanks. Welding means are inserted into the space between the cells in a direction that extends transversely relative to the axis of the cell and to the projecting plane portions.

### BRIEF DESCRIPTION OF THE DRAWINGS

Other characteristics and advantages of the invention will appear on reading the following description of an embodiment of the invention given by way of example and with reference to the accompanying drawings, in which:

FIG. 1 is a side view of an electrochemical cell constituting a first embodiment of the invention;

FIG. 2 is a side view of two FIG. 1 cells assembled together;

FIG. 3 is a side view of an electrochemical cell constituting a second embodiment of the invention;

FIG. 4 is a front view of the FIG. 3 electrochemical cell; and

FIG. 5 is a side view of two FIG. 2 cells assembled together.

### MORE DETAILED DESCRIPTION

The invention provides a cell having at least one endpiece on one of its poles, the endpiece being suitable both for being placed against an endpiece of another cell by being moved in translation, and for being fixed thereto.

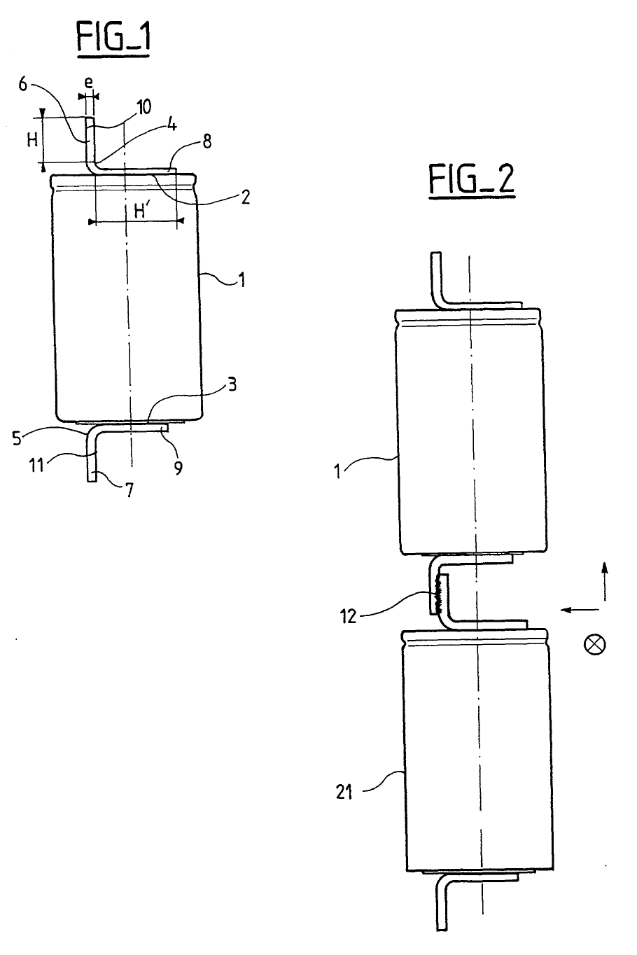

FIG. 1 shows a first embodiment of an electrochemical cell of the invention. In this embodiment, each pole presents a respective endpiece enabling two cells that are to be assembled together via their shaped endpieces to be placed plane-on-plane by movement in translation and to be fixed together. The body of the cell 1 is cylindrical in shape presenting a pole 2 at one end of the body and a pole 3 at its other end. Each of the poles 2 and 3 has a respective endpiece 4 or 5 welded thereto. Each endpiece 4 or 5 presents two substantially plane portions, one of which projects axially from the corresponding pole 2 or 3.

Each endpiece 4 or 5 is a conductive piece shaped so as to take up a position or become placed plane-on-plane on an endpiece of another cell by moving in translation and so as to be fixed thereto. In the example shown in the figure, the endpieces 4 and 5 are L-shaped angle sections each having two mutually perpendicular plane portions 6 & 8 or 7 & 9, respectively. The endpiece 4 has a projecting plane portion 6 and a plane portion 8 which is perpendicular thereto. Similarly, the endpiece 5 has a projecting plane portion 7 and a plane portion 8 which is perpendicular thereto. The projecting plane pieces 6 and 7 project axially from a corresponding pole of the cell. The plane portions 8 and 9 make contact respectively with the terminals 2 and 3.

The projecting plane portions 6 and 7 have contact and placement faces 10 and 11. The endpieces 4 and 5 are of identical dimensions in order to simplify understanding, but it is also possible to make use of endpieces having different shapes. The plane portion 6 has a height H, a depth P, and a thickness e. For simplification purposes, a plane portion 8 is described below having the same depth and thickness as the plane portion 6, and having length H′. The length H′ depends on the dimensions of the pole to which the endpiece is assembled.

Each endpiece 4 or 5 is electrically and mechanically connected to a pole by means of its plane portion 8 or 9. This connection can be made by welding, for example.

FIG. 2 shows two cells 1 and 21 as described above assembled together. The arrows represent the various movements in relative translation that are possible when assembling the endpiece 5 of the cell 1 with the endpiece 4 of the cell 21. By performing such movements in translation, it is possible to cover the face 10 of the endpiece 4 with the face 11 of the endpiece 5. These endpieces 4 and 5 thus placed against each other plane-on-plane prior to being assembled. It is thus possible for two endpieces of two cells that are to be fixed together to be placed plane-on-plane merely by performing movement in translation. This placement serves to impede three degrees of freedom in rotation and two degrees of freedom in translation.

The endpiece 4 is fixed to the endpiece 5 e.g. by welding 12 along the flanks of the plane portions 6 and 7 of the endpieces, or by laser welding, or by riveting. The length H of the plane portion 6 is sufficient to allow a fixing tool to pass. Once the endpieces 4 and 5 have been placed against each other, an intermediate space of height not less than H is thus available to receive tools between the cells to be connected together. For example, for welding, this space allows two welding electrodes to be moved towards each other so as to clamp onto the plane portions 6 and 7. The space left empty makes it possible to use electrodes of large dimensions so as to apply a high level of force when clamping the plane portions together. Applying a clamping force serves to improve the quality of the welding and to reduce impedance through the assembly. Since access to the electrodes extends transversely relative to the axes of the cells, it is also possible to clamp the plane portions 6 and 7 against each other without applying any force on the body of either cell. This makes it possible to apply high clamping forces without damaging the cells. For laser welding, the gap left between the cells allows the laser beam to pass for welding purposes. This gap also improves cooling of the cells in the resulting battery while it is in operation because of improved air circulation.

The face 10 is parallel to the face 11. These faces are also parallel to the axis of their cell. Thus, by fixing together two similar cells such as the cells 1 and 21 each having endpieces that are shaped so as to be assembled together by being moved in translation, assembly can be performed easily and the axes of the cells can be arranged colinearly.

Furthermore, in this embodiment, the plane portion 6 is offset relative to the plane portion 7. This offset is such that the axes of two assembled-together cells are in alignment. This can be achieved merely by ensuring that the contact faces 10 and 11 on a single cell are coplanar. This offset also makes it possible to distinguish between the poles of a single cell. This makes it possible to avoid inadvertently assembling two cells together via same-polarity poles.

In a variant of the invention, the endpieces are conductive pieces whose faces 10 and 11 are nickel-plated so as to improve their ability to withstand corrosion.

The thickness e of the conductive material used for the endpieces is a function of the section of the endpieces and the magnitude of the current they are to pass. It is thus preferable to select a thickness which is greater than 1.5 millimeters (mm).

For a cell of height 70 mm and diameter 40 mm, it is possible to use endpieces having the following dimensions in particular: P=18 mm, H=20 mm, and e=2.5 mm.

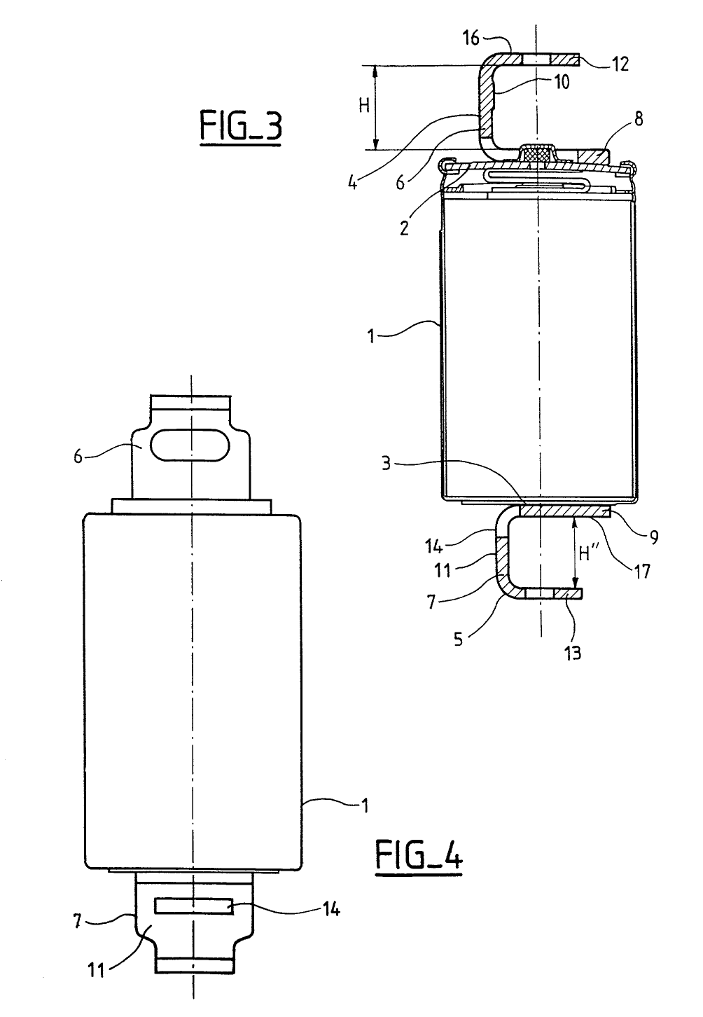

FIGS. 3 and 4 show a second embodiment of an electrochemical cell of the invention. In this embodiment, the cells made in this way have plane faces perpendicular to the cell axis thus enabling cells to be connected together directly. The cell 1 has a body similar to the embodiment described above. Endpieces 4 and 5 are placed on its poles 2 and 3 respectively and they project axially from the poles.

In the example shown in the figure, the endpieces 4 and 5 are angle-section members having a U-shaped channel section in a plane containing the axis of the cell. Each endpiece 4 or 5 presents three substantially plane portions 4, 8, & 12 or 7, 9, & 13, respectively. The endpiece 4 has a plane portion 8 which forms a first flange of a channel. The plane portion 6 forms the web of the channel and connects the plane portion 8 to a plane portion 12 forming the second flange of the channel. Similarly, the endpiece 5 has a plane portion 9 forming a first flange of a channel. A plane portion 7 forms the web of the channel and connects the plane portion 9 to a plane portion 13 which forms the second web of the channel. The portions 8 and 12 are spaced apart by a gap H. This distance corresponds to the height of the plane portion 6. The portions 9 and 13 are spaced apart by a gap H″. This distance corresponds to the height of the plane portion 7. The gap H″ is preferably smaller than the gap H, so as to make it easy to place the endpieces against one another. The endpiece 5 has an opening 14 near the junction between the portions 7 and 9. The portions 9 and 12 present respective faces 17 and 16 that come into contact when the two cells are placed against each other and are then fixed together. For simplification purposes, the plane portions of the endpieces 4 and 5 have the same thickness e as in the example shown in FIGS. 3 and 4.

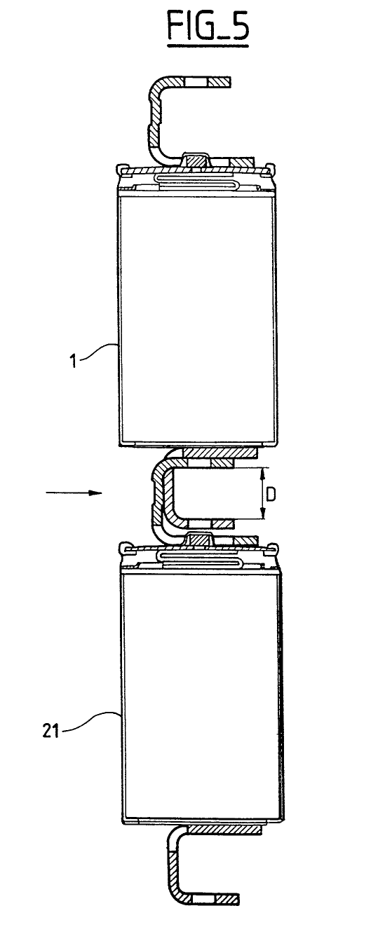

FIG. 5 shows two cells 1 and 21 as described above when assembled together. The arrow shows the direction of relative movement in translation for assembling the endpiece 5 of the cell 1 with the endpiece 4 of the cell 21. During this movement in translation, the portion 12 of the endpiece 4 passes through the opening 14 in the endpiece 5. The plane portion 12 is prevented from moving along the axis of the cells both by the portion 9 and by the portion 7 when it is engaged in the opening 14. The endpieces 4 and 5 are thus placed against each other plane-on-plane prior to being fixed together. Relative movement between two cells is then very restricted. It is thus possible to cause the endpieces of two cells that are to be assembled together to be placed against each other mutually merely by a movement in translation.

The cells of the second embodiment can be fixed together by various methods such as those described for the preceding embodiment. Once the endpieces 4 and 5 are placed against each other, there is likewise an intermediate gap between the portions 12 and 13. The height of this gap is D=(H″−e). This gap suffices as in the first embodiment to allow tooling to pass for the purpose of fixing the cells together.

The invention also provides an assembly comprising a first electrochemical cell and a second electrochemical cell, each cell having at least one endpiece. The endpiece of the second cell is preferably identical to the endpieces of the first cell, but it would also be possible to use endpieces of different shapes. The second cell is not necessarily identical to the first cell. Thus, it is advantageous to use a second cell having only one endpiece so as to be able to locate it at one end of a stick assembly. It can then be connected to appropriate outside components.

Finally, the invention provides a method of assembling two cells together. The method comprises a step of positioning a first cell with an endpiece of the type described above. Thereafter, a second cell having an endpiece, e.g. identical to an endpiece of the first cell is moved up thereto. The projecting plane portions of the two endpieces of the two cells are then placed against each other, plane-on-plane, by a movement in translation. Thereafter, the two endpieces are fixed together.

The present embodiments and examples should be considered as being given purely by way of non-restricting illustration, and the invention is not limited to particular details given above, but can be modified while remaining within the context of the scope of the accompanying claims. In particular, it is possible to provide a cell having a first endpiece presenting two plane portions and a second endpiece presenting three plane portions. The shape of the cell body is cylindrical in both of the described embodiments, but it could equally well have some other shape, for example it could be prismatic.

1/ An electrochemical cell presenting two poles disposed on opposite faces, at least one of the poles having a conductive endpiece presenting at least one substantially plane portion projecting from said pole axially relative to the cell, said endpiece being shaped so as to be suitable for assembling with an endpiece of another electrochemical cell by a movement in translation in such a manner that said projecting plane portions of each of said endpieces placed against each other, plane-on-plane.

2/ An electrochemical cell according to claim 1, in which said endpiece presents at least two substantially plane perpendicular portions.

3/ An electrochemical cell according to claim 1, in which the endpieces are made of angle sections.

4/ A cell according to claim 3, wherein said angle section has a U-shaped section.

5/ A cell according to claim 3, in which said angle section has an L-shaped section.

6/ An electrochemical cell according to claim 1, in which said projecting plane portion has an opening shaped to receive a portion of an endpiece of another electrochemical cell passing therethrough.

7/ A cell according to claim 1, wherein the two endpieces present coplanar faces for placing against faces of endpieces of other cells.

8/ An assembly comprising a first electrochemical cell and a second electrochemical cell, each of said cells having at least one endpiece according to claim 1.

9/ An assembly according to claim 8, in which said second electrochemical cell has an endpiece identical to the endpiece of said first cell.

10/ An assembly according to claim 8, in which a space giving access to the projecting plane portions is provided between the electrochemical cells when the endpieces are placed one against the other.

11/ An assembly according to claim 10, in which the length of the projecting plane portion is sufficient to enable a fixing tool to pass.

12/ An assembly according to claim 8, in which the axes of said cells are colinear.

13/ A method of assembling together two electrochemical cells according to claim 1, the method comprising the steps consisting in:
placing projecting plane portions of two endpieces of the two cells in plane-on-plane contact by a movement in translation; and
fixing the two endpieces to each other.

14/ A method according to claim 13, in which the step of fixing the two endpieces together includes a stage of welding the endpieces along their flanks.
